(19) United States
(12) Patent Application Publication
(10) Pub. No.: US 2024/0169455 A1
(43) Pub. Date: May 23, 2024

(54) SYSTEM AND METHOD FOR ASSET OR PROPERTY SEARCH OF COMMON INTEREST

(71) Applicant: Nikolas Mercado, Washington, DC (US)

(72) Inventor: Nikolas Mercado, Washington, DC (US)

(21) Appl. No.: 18/386,458

(22) Filed: Nov. 2, 2023

Related U.S. Application Data
(60) Provisional application No. 63/421,962, filed on Nov. 2, 2022.

(51) Int. Cl. G06Q 50/16; G06Q 30/0601

(52) U.S. Cl. CPC G06Q 50/16; G06Q 30/0625; G06Q 30/0641

(57) ABSTRACT

The exemplary embodiments provide a computer implemented method for search and purchase of real estate including: establishing a purchasing group including at least two users for purchase of at least one real estate property; receiving, from the purchasing group, purchase parameters for purchase of at least one real estate property; determining at least one real estate property corresponding to the purchase parameters; receiving, from the purchasing group, a selection of at least one of the corresponding real estate properties for purchase by the group; determining, by at least one financial institution, whether the purchasing group is financially qualified to purchase the selected at least one property; and communicating purchase cost information for purchase of the at least one real estate property to the purchasing group.

### BACKGROUND OF THE INVENTION

### 1. Field of the Invention

The present general inventive concept relates to methods, systems, and apparatus configured to facilitate asset and property searches as well as purchase. In particular, the exemplary embodiments relate to methods and an apparatus for multiple individuals or entities to search for an asset or property satisfying a common interest, and to purchase the asset or property as a combined entity.

### 2. Description of Related Art

There have been previous methods and systems that have been developed that facilitate the surge in purchase of assets or property. However, the prior art fails to resolve numerous issues in the process of searching for and purchasing a property. The prior methods and systems are time consuming, do not provide an efficient method to estimate and obtain financing options, and generally require the use of multiple different systems to obtain all necessary information for searching for and purchasing a property that satisfies a common interest of multiple individuals. Further, real estate marketplaces make it difficult to buy a property and require users to use multiple websites and services to identify their purchase power and navigate.

Therefore, what is desired is a method and apparatus that is configured to identify a common interest of multiple individuals searching for a property or asset. Further desired is a method or apparatus for property search and purchase that saves time, energy, and other resources, that enables common interests to be established through easy system inputs, that enables quick sharing of properties of interest, and that communicates properties of common interest to members of a search group. Further desired is a real estate property marketplace that unlocks purchase power and uses artificial intelligence as a co-pilot to help navigate the property search and purchase, creating a more controlled, efficient, and streamlined user experience.

### BRIEF SUMMARY OF THE INVENTION

The present general inventive concept provides, in one embodiment, a computer implemented method for search and purchase of real estate. The method includes establishing a purchasing group including at least two users for purchase of at least one real estate property. The method further includes receiving, from the purchasing group, purchase parameters for purchase of at least one real estate property. The method further includes determining at least one real estate property corresponding to the purchase parameters. The method further includes receiving, from the purchasing group, a selection of at least one of the corresponding real estate properties for purchase by the group. The method further includes determining, by at least one financial institution, the financial qualifications of the purchasing group. The method further includes communicating purchase cost information for purchase of the selected at least one real estate property to the purchasing group.

In alternative embodiments, the method further includes establishing communication between the users in the group, receiving, from the purchasing group, a decision to purchase the selected at least one real estate property, and establishing communication between a seller of the selected at least one real estate property, at least one financial institution, and the purchasing group for purchase of the selected at least one real estate property by the group.

In alternative embodiments, the step of determining, by at least one financial institution, the financial qualifications of the purchasing group includes obtaining financial information corresponding to each respective user in the group, communicating the financial information of each respective user to the at least one financial institution, and receiving, from the financial institution, a determination whether the purchasing group as a whole is financially qualified to purchase at least one real estate property based on the combined financial information of each user.

In alternative embodiments, communicating purchase cost information for purchase of the at least one real estate property to the purchasing group includes receiving, by the purchasing group through a user interface, the purchase cost information, and enabling, through the user interface, each user, and a representative of the at least one financial institution to communicate in real time about the purchase cost information.

In alternative embodiments, the purchase cost information includes at least a mortgage payment, homeowner's association fees, mortgage insurance, home insurance, and taxes.

In alternative embodiments, the step of determining at least one real estate property corresponding to the purchase parameters includes storing data corresponding to respective purchase parameters and selected real estate properties of each user, filtering, from a plurality of real estate properties, for at least one real estate property corresponding to the respective stored data for each user.

In alternative embodiments, the method further includes enabling each user, during the search and purchase of the at least one real estate property, to interact with artificial intelligence via the user interface.

In alternative embodiments, establishing a purchasing group includes receiving, from a first user, a selection of at least one other user to join a purchasing group initiated by the first user.

In alternative embodiments, establishing a purchasing group receiving, from a first user, purchase parameters for the group and enabling at least one other user to join the first user based on the first user's purchase parameters.

In alternative embodiments, establishing a purchasing group includes receiving, from the first user, a request to be matched with at least one other user, and determining at least one real estate property corresponding to the purchase parameters includes filtering, from the plurality of real estate properties, for a real estate property having been previously selected by the first user for combined purchase with at least one other user.

In alternative embodiments, the method is implemented through a computer apparatus comprising at least a processor and a memory configured to store code executable by the processor.

In alternative embodiments, the step of determining the financial qualification of the purchasing group occurs prior to receiving purchase parameters from the purchasing group.

The present general inventive concept provides, in another embodiment, an apparatus that includes a processor and a memory that stores code executable by the processor to establish a purchasing group including at least two users for purchase of at least one real estate property, receive, from the purchasing group, purchase parameters for purchase of at least one real estate property, determine at least one real estate property corresponding to the purchase parameters, receive, from the purchasing group, a selection of at least one of the corresponding real estate properties for purchase by the group, determine, by at least one financial institution, whether the purchasing group is financially qualified to purchase the selected at least one real estate property, communicate purchase cost information for purchase of the at least one real estate property to the purchasing group.

In alternative embodiments, the code executable by the processor is further operative to establish communication between the users in the group; receive, from the purchasing group, a decision to purchase the selected at least one real estate property, and establish communication between a seller of the selected at least one real estate property, at least one financial institution, and the purchasing group for purchase of the selected at least one real estate property by the group.

In alternative embodiments, determining, by at least one financial institution, whether the purchasing group is financially qualified to purchase the selected at least one real estate property includes obtaining financial information corresponding to each respective user in the group, communicating the financial information of each respective user to the at least one financial institution, and receiving, from the financial institution, the determination whether the purchasing group as a whole is financially qualified to purchase the at least one real estate property based on the combined financial information of each user.

In alternative embodiments, the code executable by the processor is further operative to enable each user, during the search and purchase of the at least one real estate property, to interact with artificial intelligence via the user interface.

In alternative embodiments, establishing a purchasing group comprises at least one of: receiving, from a first user, a selection of at least one other user to join a purchasing group initiated by the first user; receiving, from a first user, purchase parameters for the group and enabling at least one other user to join the first user based on the first user's purchase parameters; or receiving, from the first user, a request to be matched with at least one other user, and wherein determining at least one real estate property corresponding to the purchase parameters includes filtering, from the plurality of real estate properties, for a real estate property having been previously selected by the first user for combined purchase with at least one other user.

The present general inventive concept provides, in another embodiment, a computer implemented method for search and purchase of real estate. The method includes enabling a first user to establish a purchasing group including at least one other user, establishing communication between users in the purchasing group, receiving, from the purchasing group, purchase parameters for purchase of at least one real estate property, filtering, from a plurality of real estate properties, for at least one real estate property corresponding to the purchase parameters of the purchasing group, presenting the corresponding real estate properties to the purchasing group, receiving, from the purchasing group, a selection of at least one of the corresponding real estate properties from the list, obtaining, from at least one financial institution, financial information corresponding to each respective user in the purchasing group, determining whether the purchasing group is financially qualified to purchase the selected at least one real estate property based on the combined financial information of each respective user in the group, determining purchase cost information for the selected at least one real estate property specific to the purchasing group based on the obtained combined financial information of the group, communicating the combined purchase cost information to the purchasing group, receiving, from the purchasing group, a decision to purchase the selected at least one real estate property, and establishing communication between a seller of the selected at least one real estate property, at least one financial institution, and each user of the group for purchase of the selected at least one real estate property by the purchasing group.

Additional features and embodiments of the present general inventive concept will be apparent from the following detailed description, drawings, and claims.

### BRIEF DESCRIPTIONS OF THE DRAWINGS

These and/or other aspects of the present general inventive concept will become apparent and more readily appreciated from the following description of the embodiments, taken in conjunction with the accompanying drawings of which:

FIG. 1 is a schematic diagram illustrating one embodiment of an exemplary system for performing a computer implemented method for search and purchase of real estate;

FIG. 2 is a schematic block diagram illustrating one embodiment of an apparatus for performing a computer implemented method for search and purchase of real estate;

FIG. 3 is a schematic flow chart diagram illustrating another embodiment of a computer implemented method for search and purchase of real estate;

FIG. 4 is a schematic flow chart diagram illustrating another embodiment of a computer implemented method for search and purchase of real estate; and

FIG. 5 is a schematic flow chart diagram continuing the embodiment illustrated in FIG. 4.

### DETAILED DESCRIPTION OF THE INVENTION

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

Those skilled in the art will appreciate that aspects of this invention can be embodied as a system, method, or computer program product. This means that aspects of the invention can take the form of hardware only, software only, or a combination of software, hardware, and firmware. Exemplary embodiments may generally be described as a circuit, module, or system. Alternative embodiments include computer program products embodied in one or more computer-readable media containing program code.

As described herein, many functions of the present general inventive concept are described as modules, such as hardware circuits or programmable hardware. Modules can also be implemented in software or code executable by processors. The software or code may include one or more groups of computer instructions, organized as objects, procedures, or functions. Module instructions, software, or code can be stored together or in separate storage mediums, but when logically joined together, they comprise a module for executing the functions, operations, and actions discussed herein.

Embodiments of computer program products may include a computer-readable storage medium with program instructions for carrying out aspects of the invention. Computer-readable storage media can store instructions for use by a processor. They can be electronic, magnetic, optical, electromagnetic, or semiconductor. Computer-readable program instructions can be downloaded to devices from a storage medium or over a wired or wireless network, or combination thereof. Computer-readable program instructions for carrying out operations of the invention may be written in any programming language and may run on the user's computer, partly on the user's computer, as a standalone software package, partly on the user's computer and partly on a remote computer, or entirely on a remote computer.

This invention is described using flowcharts, block diagrams, or both, of methods, systems, and computer program products. Each block in the diagrams, and combinations of blocks, can be implemented by computer-readable program instructions. The flowchart and block diagrams in the figures show possible implementations of the invention. Each block may represent a module, segment, or portion of code that implements the specified logical function(s). In some cases, the functions in a block may occur in a different order than shown in the figures. For example, two blocks shown in succession may be executed concurrently, or in the reverse order. Other steps and methods may be equivalent to one or more blocks, or portions of blocks, in the figures. The arrow and line types in the flowchart and block diagrams do not limit the scope of the corresponding embodiments. For example, an arrow may indicate a waiting or monitoring period. Each block, or combination of blocks, can be implemented by special purpose hardware or a combination of hardware and software.

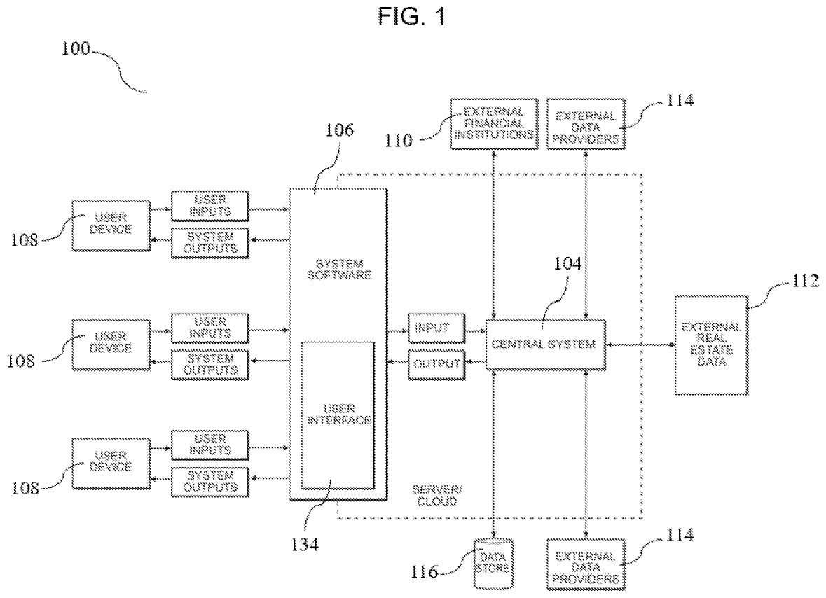

FIG. 1 is a schematic diagram illustrating one embodiment of an exemplary system for performing a computer implemented for search and purchase of real estate.

Referring to FIG. 1, the property search and purchase method and apparatus, designated generally as 100, is illustrated. In the present embodiment, the property search and purchase method and apparatus 100 is designed and configured as a method and apparatus that enables individuals to form a group for the search and purchase of property by combining the resources of all members in the group. However, the present general inventive concept is not limited thereto.

The present invention provides, in one embodiment, a computer implemented method for search and purchase of real estate 100. The method is implemented via a computer system 102. The computer system 102 includes in connection therewith a central control system 104, system software 106, a plurality of user devices 108, financial institutions 110, real estate data provider 112, other external data providers 114, and a data store 116. However, the present general inventive concept is not limited thereto.

In exemplary embodiments, the central system 104 comprises one or multiple processors, servers, or other computing devices configured to communicate with other computing devices via a wired or wireless network.

Central system 104 is configured to execute system software 106 which includes processor readable instructions for carrying out the methods, operations, functions and other actions of the exemplary embodiments. The system software is stored in data stores, servers, clouds, user devices, processor readable mediums and other memory or storage devices. The system software includes a user interface 134 that enables users to interact with and use the central system 104.

Users of the exemplary embodiments can interact with and use central system 104 through user devices 108 that are configured to execute the system software 106. The user devices 108 include, but are not limited to, smartphones and other smart devices, computers, smart tablets, or any other personal computing devices.

Financial institutions 110 include, but are not limited to, banks, credit unions, mortgaging entities or individuals, and other lending institutions.

External real estate data providers 112 include, but are not limited to, real estate related companies, websites, institutions, individual real estate sellers and any other real estate related entities.

External data provides 114 include, but are not limited to, credit rating companies, loan document processing companies, interest rate providers, real estate title insurers and other entities generally associated with real estate transactions.

Data store 116 comprises any of the memory or storage devices or systems previously discussed.

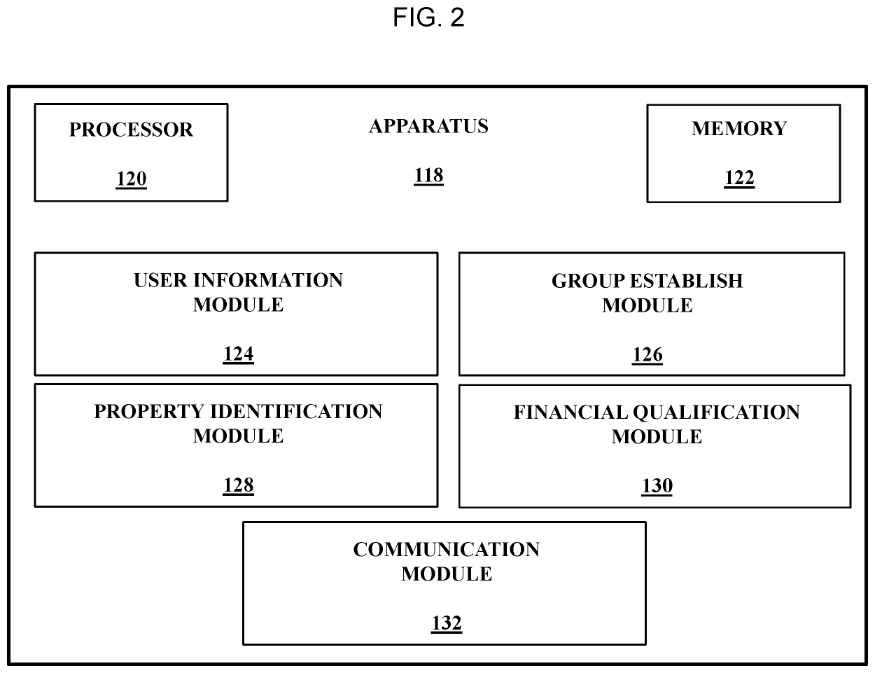

FIG. 2 is a schematic block diagram illustrating one embodiment of an apparatus for performing a computer implemented method for search and purchase of real estate.

Referring to FIG. 2, an apparatus 118 for search and purchase of real estate is described using modules, which include any of the module configurations previously discussed. In exemplary embodiments, module 118 comprises a combination of at least one data store, processor executable code, and at least one processor for executing or facilitating the operations, functions, and other actions of the method performed by apparatus 118. However, the present general inventive concept is not limited thereto.

Apparatus 118 includes a processor 120 and a memory 122. The apparatus further includes a user module 120. The user module 120, in one embodiment, is configured to receive user inputs of information from a plurality of users via user devices 108, and to cause outputs from control system 104 to be displayed on user devices 108 of the users.

The user information that is input into the user module 124 includes, but is not limited to, user identifying information such as names, phone numbers, e-mail addresses, physical residential or business addresses, social security numbers, as well as any other information used to identify a user. The user information further includes financial information such as banking information, income and expenses, credit ratings and history as well as any other financial information used during the purchase of real estate or other assets.

The user information further includes purchase parameters. Purchase parameters include information utilized by the central system 104 to determine or identify real estate properties or assets of interest to the user. The purchase parameters may include defined geographic areas, number of rooms and bathrooms, acreage of land, down payment amounts, mortgage amounts, home insurance costs, homeowners' association fees, mortgage insurance, taxes, and any other information related to searching for and purchasing real estate property.

The apparatus 118 further includes a group establishing module 126. The group establishing module 126 is configured to establish a purchasing group for purchase of at least one real estate property. The exemplary purchasing group includes at least two users. In one embodiment, the group establishing module 126 is operative to establish a group of users based on the purchase parameters of each respective user. For example, the group establishing module 126 may group users based on geographic parameters of the user, financial parameters of the user, or any other purchase parameters. The group establishing module 126 may optimize a group by combining users based on their user information, such as the user's financial information, to group users to achieve optimal purchasing capacity.

In alternative embodiments, the group establishing module 126 is configured to establish the purchasing group by receiving, from a user, a selection of at least one other user to join a purchasing group initiated by the first user. In such embodiments, the user is enabled to make an input into the system 104 via the user interface 134 on the user device 108 to indicate an intent to establish a purchasing group. Thereafter, the user is enabled to make another input into system 104 to indicate another user to be matched with to establish the purchasing group.

In other alternative embodiments, the group establishing module 126 is configured to establish the purchasing group by receiving, from a user, purchase parameters for a purchasing group, and enabling at least one other user to join the purchasing group based on the first user's purchase parameters. In such embodiments, the first user makes inputs into the system 104 indicating an intent to start a purchasing group and purchase parameters for such group. Thereafter, other users may make inputs into the system 104 to indicate an intent to join the first user's purchasing group because the other user has found the first user's purchase parameters for the group desirable.

In other alternative embodiments, the group establishing module 126 is configured to establish the purchasing group by receiving, from a first user, a request to be matched with at least one other user. In such embodiments, the group establishing module 126 works in tandem with a property identification module, which will be later discussed, to filter, from a plurality of real estate properties, for a real estate property having been previously selected by the first user for combined purchase with at least one other user. In this embodiment, the first user makes inputs into the system 104 indicating the first user would like to establish a purchasing group, and the first user makes inputs into the system 104 indicating at least one real estate property that the first user would like to purchase with the group. Thereafter, other users may join the first user's purchasing group to purchase the real estate property selected by the first user if the other users also find the first user selected real estate property desirable.

Apparatus 118 further includes a property identification module 128. The property identification module 128 is configured to determine at least one real estate property corresponding to the purchase parameters of the purchasing group. The property identification module 128 is operative to filter, from a plurality of real estate properties, for at least one real estate property meeting the purchase parameters of the purchasing group.

The property identification module 128 is operative to communicate via the control system 104 with external real estate data providers 112 to obtain a list of real estate properties available for purchase in each area. The list of available real estate properties is stored in data store 116. The external real estate data providers 112 include, but are not limited to, real estate agents, real estate companies, individual sellers of real estate, real estate websites, or any other source of information for real estate available for purchase.

Apparatus 118 further includes a financial qualification module 130. The financial qualification module 130 is configured to determine, by at least one financial institution 110, the financial qualifications of the purchasing group. The financial qualification module 130 is also configured to determine, by at least one financial institution 110, whether the purchasing group is financially qualified to purchase the selected at least one real estate property. The financial qualification module 130 is configured to obtain, through control system 104, financial information corresponding to each respective user in the purchasing group. Module 130 is further configured to communicate the financial information of each respective user to at least one financial institution 110. The module 130 is further configured to receive, from the financial institution 110, the determination whether the purchasing group as a whole is financially qualified to purchase the at least one real estate property based on the combined financial information of each user.

The exemplary financial institution 110 may be a bank, a credit union, a mortgage provider or lender or any other individual or entity that lends money for the purchase of real estate property. In such embodiments, system 104 communicates the financial information of each of the users in the purchasing group to the financial institution 110. The financial institution 110 uses its own processes to determine whether the combined financial information of all the users in the purchasing group is sufficient to qualify the purchasing group as a whole for a loan to purchase the selected real estate property. Financial institution 104 communicates the financial qualification determination to the system 104. However, the present general inventive concept is not limited thereto.

In alternative embodiments, upon financial qualification of a user or purchasing group, the users are enabled to search in a pre-qualified status. That is, in certain embodiments, the users proceed with financial qualification before searching for real estate properties. In such embodiments, the users first make user inputs into central system 104 via the user interface 134 on the user devices 108 to enable the central system 104 to proceed with financial qualification of the user prior to the users performing a property search. Thereafter, during the user's search, the search is tailored based on the financial qualifications of the user. In such embodiments, system 104 is configured to provide personalized pricing on real estate properties based on the financial qualification of the user. System 104 may recommend down payments, monthly mortgage payments and other real estate transaction costs and fees or purchase cost information to the user based on the financial qualifications of the user. In such embodiments, the system 104 is configured to determine an individual user's or purchasing group purchasing capacity based on the financial qualification by the financial institution 110, and the user's search is optimized based on the purchasing capacity.

Apparatus 118 further includes a communication module 132. The communication module 132 provides multiple communication functions. Communication module 132 is configured to communicate purchase cost information for purchase of the at least one real estate property to the purchasing group. Module 132 is configured establish communication between the users in the purchasing group. Module 132 is configured to establish communication between a seller or seller's representative of the real estate property, the at least one financial institution, and the purchasing group for purchase of the real estate property.

In exemplary embodiments, purchase cost information includes, but is not limited to, mortgage payments, homeowner's associations fees, mortgage insurance fees, home insurance fees, title search and clearance fees, title insurance fees, property taxes and other taxes, property inspection fees, as well as any costs or fees associated with real estate transactions.

In alternative embodiments, central system 104 is configured to determine a user specific projected price for each user in the group as well as a combined projected price for the purchasing group that includes, but is not limited to, a down payment and interest. In such embodiments, the user is pre-qualified financially. In such embodiments, the user or purchasing group receives the projected price prior to searching for a real estate property to enable a personalized search that only displays properties within the users financial purchasing power.

The communication module 132 includes a user interface 134 of system software 106 that is utilized by the seller of the real estate property, the at least one financial institution, and each member of the purchasing group. The user interface 134 is displayed on the respective user devices 108 of each respective user, electronic devices associated with sellers of the real estate properties, and electronic devices associated with representatives or agents of the financial institutions 110. In exemplary embodiments, the user interface 134 includes a messaging platform for each member of the purchasing group to collaboratively communicate about real estate properties, costs, and other related topics.

The exemplary user interface 134 further provides a communication platform for the members of the purchasing group individually or collectively to communicate with representatives or agents of the financial institutions 110. Such communication platform enables the financial institution 110 to manage connections, offers, documents, and other communications with a plurality of real estate purchasers or users. However, the present general inventive concept is not limited thereto.

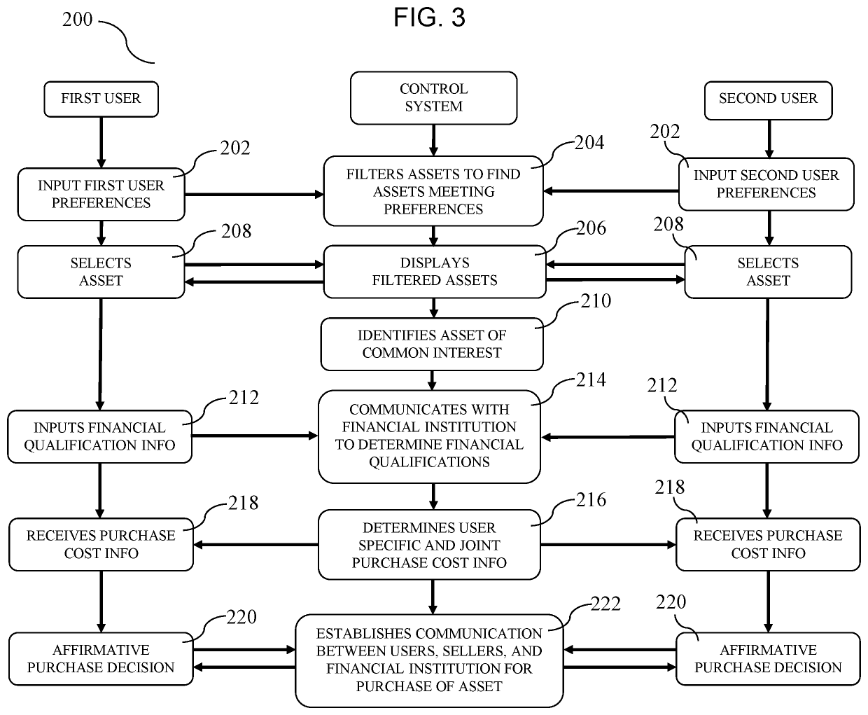

FIG. 3 is a schematic flow chart diagram illustrating another embodiment of a computer implemented method for search and purchase of real estate.

Referring to FIG. 3, another embodiment of a computer implemented method for search and purchase of real estate 200 is provided. Method 200 is implemented via a computer system including all of the features and relationships of computer system 102. Method 200 may be implemented using the same module approach of apparatus 118.

The computer implemented method 200 for search and purchase of real estate, includes, in a first step 202 with a first user and a second user accessing the system software 106. During step 202, the users input into the central system 104 purchase preferences or parameters including the purchase parameters previously discussed. Central system 104 is configured to receive the purchase parameters of the users and to store them in the data store 116.

At step 204, the central system 104 is configured to filter from a plurality of real estate properties or other assets for a real estate property corresponding to the purchase parameters of the first user and the second user. The central system 104 is configured to store in the data store 116 real estate properties meeting the purchase parameters of both the first user and the second user and to determine real estate properties that meet both the purchase parameters of the first and second user.

At step 206, the central system 104 is configured to cause the real estate properties that are stored in the data store 116 and meet the purchase parameters of the first and second user to be displayed to the first and second user. For example, the central system 104, through use of the system software 106, is operative to cause the real estate properties to be displayed on a user device 108 of the first or second user.

At step 208, the central system 104 is configured to receive a selection of at least one of the real estate properties stored by the central system 104 that meets the purchase parameters of both the first and second user. During step 208, the first and second user make at least one input to the user interface 134 of the system software 106 on user devices 108 to select at least one of the real estate properties meeting the purchase parameters. Central system 104 is configured to store the selection of the at least one real estate properties by each user in the data store 116.

At step 210, the central system 104 is configured to identify a real estate property or asset of common interest based on the received selections from the users in step 208. Central system 104 is configured to store the identified properties or assets of common interest in the data store 116.

At step 212, the central system 104 is configured to prompt the first user and the second user to make an input to the system software 106 of the user's specific financial qualification information or financial information. The financial information input into system 104 by the users includes any of the financial information previously discussed. The central system 104 is configured to receive the financial information from the users and to store the financial information from the user in the data store 116 in a secure manner to avoid any unintentional disclosure of personal or financial information of the user.

At step 214, the central system 104 is configured to communicate with at least one financial institution 110 to determine the financial qualifications of each specific user. That is, the central system 104 is configured to communicate with a plurality of financial institutions 110 because each user may have a different bank, credit union, or other type of financial institution. During step 214, The central system 104 is determining the financial qualifications of the users, obtaining mortgage or lender information based on the user's financial information. Central system 104 may also use a single financial institution to obtain financing information, financial qualifications, and other lender or mortgage related information for the users to purchase the real estate properties.

At step 216, the central system 104 is configured to determine user specific or combined purchase cost information for the users to purchase the real estate properties. That is, the central system 104 is configured to utilize information from the financial institution 110 to determine purchase cost information for purchase of the real estate properties by the users. The purchase cost information includes any of the purchase cost information previously discussed. Central system 104 is configured to cause the purchase cost information to be stored in the data store 116.

At step 218, the central system 104 is configured to cause the purchase cost information to be displayed on the user devices 108 of the users via the system software 106 and user interface 134.

At step 220, the central system 104 is configured to receive from the users an affirmative decision to purchase the real estate properties. For example, the users individually make at least one input into the user interface 134 on their devices 108 to indicate that the user would like to move forward with the purchasing process and closing of the real estate properties. In the alternative, the first user and second user may have already agreed that one of the first user and the second user is the representative of the group and the representative inputs an indication that the group of users would like to move forward with the purchase and closing.

At step 222, the central system 104 is configured to establish communication between the users, sellers of the real estate properties, and financial institutions or representatives thereof for purchase of the real estate properties. The central system provides a user interface platform where the users can communicate with financial institution representatives to initiate and complete the closing of the purchase of the real estate properties. The financial institution representatives are enabled to communicate with multiple users via the user interface 134 to ensure proper collection and processing of loan or mortgage, title, insurance, and any other documents necessary to complete the closing of the real estate purchase. However, the present general inventive concept is not limited thereto.

In alternative embodiments, the first and second user may input their financial information into the system 104 prior to conducting a property search. In such embodiments, system 104 is configured to proceed with financial qualification prior to the user's property search such that the users search is tailored to real estate properties within the user's purchasing capacity.

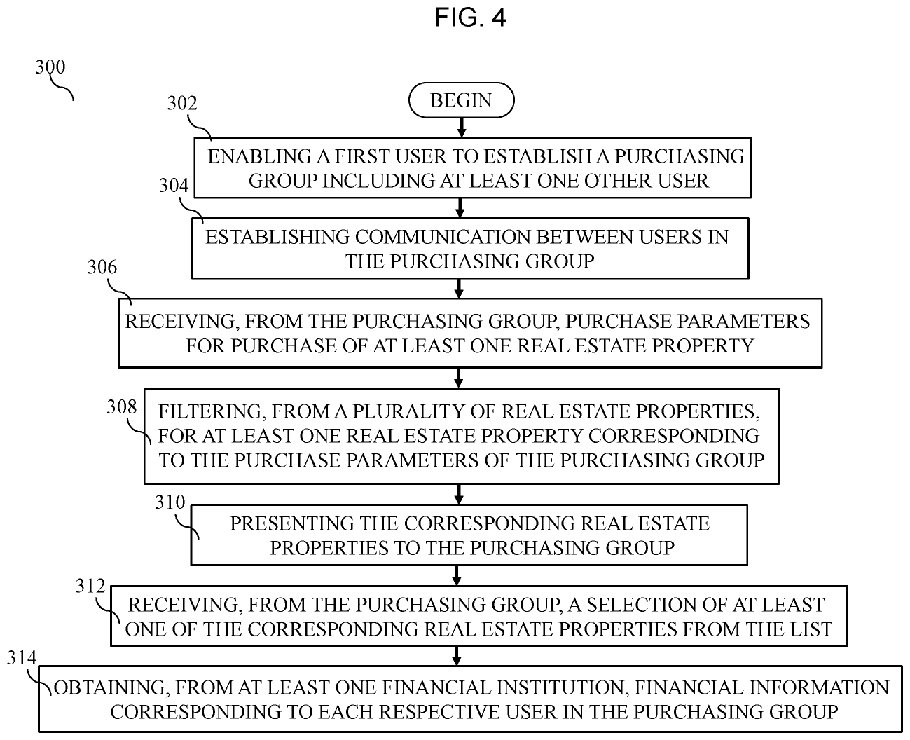

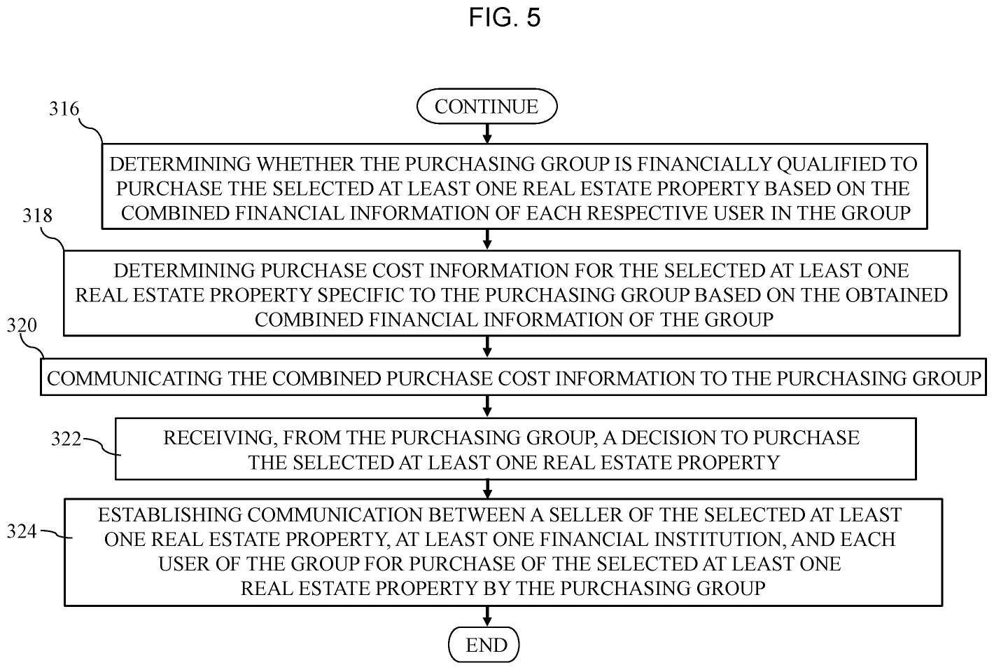

FIGS. 4-5 are a schematic flow chart diagram illustrating another embodiment of a computer implemented method for search and purchase of real estate.

Referring to FIGS. 4-5, a computer implemented method for search and purchase of real estate 300 is provided. In one embodiment, method 300 begins and enables 302 a first user to establish a purchasing group including at least one other user. Method 300 then establishes 304 communications between users and the purchasing group. The method 300 then receives 306, from the purchasing group, purchase parameters for purchase of at least one real estate property. Method 300 then filters 308, from a plurality of real estate properties, for at least one real estate property corresponding to the purchase parameters of the purchasing group. Method 300 then presents 310 the corresponding real estate properties to the purchasing group. Method 300 then receives 312, from the purchasing group, a selection of at least one of the corresponding real estate properties from the list. The method 300 then obtains 314, from at least one financial institution, financial information corresponding to each respective user in the purchasing group. Method 300 then determines 316 whether the purchasing group is financially qualified to purchase the selected at least one real estate property based on the combined financial information of each respective user in the group. The method 300 then determines 318 purchase cost information for the selected at least one real estate property specific to the purchasing group based on the obtained combined financial information of the group. The method 300 then communicates 320 the combined purchase cost information to the purchasing group. The method 300 then receives 322, from the purchasing group, a decision to purchase the selected at least one real estate property. The method 300 ends establishing 324 communications between a seller of the selected at least one real estate property, at least one financial institution, and each user of the group for purchase of the selected at least one real estate property by the purchasing group. However, the present general inventive concept is not limited thereto.

In alternative embodiments, the first and second user may input their financial information into the system 104 prior to conducting a property search. In such embodiments, system 104 is configured to proceed with financial qualification prior to the user's property search such that the users search is tailored to real estate properties within the user's purchasing capacity.

In alternative embodiments, the user financial information such as banking information and credit history may be obtained automatically by system 104. In such embodiments, system 104 may incorporate other software such as Plaid® to automatically retrieve banking information or credit history related to a user. However, system 104 may use other software to automatically retrieve financial information.

In alternative embodiments, system 104 is configured to enable users to communicate and interact with artificial intelligence during the search and purchase of the at least one real estate property. That is, the user interface 134 of the system software 106 includes an artificial intelligence module in which the user is enabled to ask questions and obtain information about the user's search and purchase of real estate from the artificial intelligence. In exemplary embodiments, the artificial intelligence module provides a messaging platform for text based artificial intelligence. The exemplary system 104 may include its own artificial intelligence code or instructions stored in the data store 116, or the exemplary system 104 may be configured to connect with pre-existing artificial intelligence programs available to the public.

In alternative exemplary embodiments, system 104 is configured to utilize machine learning in order to improve itself. In such embodiments, system 104 is configured to track and store in the data store 116 user interactions with the user interface 134 of the system software 106 to optimize user experience and property searches for efficiency. The system software 104 may track user interactions with the user interface 134 such as the amount of time spent looking at a real estate property displayed to the user by the system 104, previously liked properties, previously purchased properties, previous search terms, or other characteristics of the user's search habits indicative of their subjective preferences for real estate properties. During future searches, system 104 is configured to utilize this stored data corresponding to the user's search preferences to display real estate properties to the user that are more in line with the user's subjective preferences. Of course, machine learning may be used to improve other operations of system 104 as well.

In alternative embodiments, the user interface 134 of system software 106 includes a swiping function for users to indicate interest in a real estate property. That is, after reviewing a property, if a user is interested in purchasing the property, the user simply swipes with at least one finger across a display screen of their user device 108 to indicate the user's interest in the property. After the user has swiped on the property, the system software 104 is configured to store data corresponding to the real estate property in a portion of the data store 116 specific to the user. After the user has finished their property search, the user can access via the user interface 134 the properties that have been swiped to further analyze this property. However, other user interface interactions may be used to indicate user interest in a property such as tapping a heart icon on the user interface adjacent the real estate property on the display screen of the user device 108, or double tapping an image or other portion of the property listing that is displayed on the user device.

In alternative embodiments, the user interface 134 of system software 106 enables users to manually adjust down payments amounts. Central system 104 is configured to calculate changes in monthly mortgage payments for a given real estate property based on the change in down payment amount. Central system 104 is configured to contemporaneously display the adjusted monthly mortgage payment to the users through the user interface 134.

In alternative embodiments, user interface 134 of the system software 106 includes a comments and ratings module in which a user can make inputs into the system 104 ranking properties that the user is interested in purchasing and providing comments on certain properties. In such embodiments, the users are enabled to provide information about a real estate property that cannot otherwise be represented in images or descriptions of the real estate property. User interface 134 enables users to share experiences of real estate property with comments and other information, rate properties, and post videos or other images of the real estate property.

In alternative embodiments, the user interface 134 of the system software 106 includes a property map module. Central system 104 is configured to use the property map module to display on the user devices 108 to display real estate properties in a user designated geographic area that are available for purchase. Users may select properties within the user designated area for purchase or for further review in which the selected properties are saved in a user specific portion of the data store 116.

Although a few exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. A computer implemented method for search and purchase of real estate, comprising:
establishing a purchasing group including at least two users for purchase of at least one real estate property;
receiving, from the purchasing group, purchase parameters for purchase of at least one real estate property;
determining at least one real estate property corresponding to the purchase parameters;
receiving, from the purchasing group, a selection of at least one of the corresponding real estate properties for purchase by the group;
determining, by at least one financial institution, financial qualifications of the purchasing group; and
communicating purchase cost information for purchase of the selected at least one real estate property to the purchasing group.

2. The method of claim 1, further comprising:
establishing communication between the users in the group;
receiving, from the purchasing group, a decision to purchase the selected at least one real estate property; and
establishing communication between a seller of the selected at least one real estate property, at least one financial institution, and the purchasing group for purchase of the selected at least one real estate property by the group.

3. The method of claim 2, wherein determining, by at least one financial institution, financial qualifications of the purchasing group comprises:
obtaining financial information corresponding to each respective user in the group;
communicating the financial information of each respective user to the at least one financial institution; and
receiving, from the financial institution, a determination whether the purchasing group as a whole is financially qualified to purchase at least one real estate property based on the combined financial information of each user.

4. The method of claim 3, wherein communicating purchase cost information for purchase of the at least one real estate property to the purchasing group comprises:
receiving, by the purchasing group through a user interface, the purchase cost information; and
enabling, through the user interface, each user and a representative of the at least one financial institution to communicate in real time about the purchase cost information.

5. The method of claim 4, wherein the purchase cost information comprises:
a mortgage payment;
homeowner's association fees;
mortgage insurance;
home insurance; and
taxes.

6. The method of claim 5, wherein determining at least one real estate property corresponding to the purchase parameters comprises:
storing data corresponding to respective purchase parameters and selected real estate properties of each user;
filtering, from a plurality of real estate properties, for at least one real estate property corresponding to the respective stored data for each user.

7. The method of claim 6, further comprising:
enabling each user, during the search and purchase of the at least one real estate property, to interact with artificial intelligence via the user interface.

8. The method of claim 7, wherein establishing a purchasing group comprises:
receiving, from a first user, a selection of at least one other user to join a purchasing group initiated by the first user.

9. The method of claim 8, wherein establishing a purchasing group comprises:
receiving, from a first user, purchase parameters for the group and enabling at least one other user to join the first user based on the first user's purchase parameters.

10. The method of claim 9, wherein establishing a purchasing group comprises:
receiving, from the first user, a request to be matched with at least one other user, and
wherein determining at least one real estate property corresponding to the purchase parameters comprises:
filtering, from the plurality of real estate properties, for a real estate property having been previously selected by the first user for combined purchase with at least one other user.

11. The method according to claim 10, wherein the method is implemented through a computer apparatus comprising at least one processor and at least one memory configured to store code executable by the processor.

12. The method according to claim 1, wherein the determining the financial qualification of the purchasing group occurs prior to receiving purchase parameters from the purchasing group.

13. An apparatus comprising:
at least one processor,
at least one memory configured to store code executable by the processor to:
establish a purchasing group including at least two users for purchase of at least one real estate property;
receive, from the purchasing group, purchase parameters for purchase of at least one real estate property;
determine at least one real estate property corresponding to the purchase parameters;
receive, from the purchasing group, a selection of at least one of the corresponding real estate properties for purchase by the group;
determine, by at least one financial institution, whether the purchasing group is financially qualified to purchase the selected at least one real estate property; and
communicate purchase cost information for purchase of the at least one real estate property to the purchasing group.

14. The apparatus of claim 11, wherein the code executable by the processor is further operative to:
establish communication between the users in the group;
receive, from the purchasing group, a decision to purchase the selected at least one real estate property; and
establish communication between a seller of the selected at least one real estate property, at least one financial institution, and the purchasing group for purchase of the selected at least one real estate property by the group.

15. The apparatus of claim 12, wherein determining, by at least one financial institution, whether the purchasing group is financially qualified to purchase the selected at least one real estate property comprises:
obtaining financial information corresponding to each respective user in the group;
communicating the financial information of each respective user to the at least one financial institution; and
receiving, from the financial institution, the determination whether the purchasing group as a whole is financially qualified to purchase the at least one real estate property based on the combined financial information of each user.

16. The apparatus of claim 13, wherein communicating purchase cost information for purchase of the at least one real estate property to the purchasing group comprises:
receiving, by the purchasing group through a user interface, the purchase cost information; and
enabling, through the user interface, each user and a representative of the at least one financial institution to communicate in real time about the purchase cost information.

17. The apparatus of claim 15, wherein determining at least one real estate property corresponding to the purchase parameters comprises:
storing data corresponding to respective purchase parameters and selected real estate properties of each user; and
filtering, from a plurality of real estate properties, for at least one real estate property corresponding to the respective stored data for each user.

18. The apparatus of claim 16, wherein the code executable by the processor is further operative to:
enable each user, during the search and purchase of the at least one real estate property, to interact with artificial intelligence via the user interface.

19. The apparatus of claim 17, wherein establishing a purchasing group comprises at least one of:
receiving, from a first user, a selection of at least one other user to join a purchasing group initiated by the first user;
receiving, from a first user, purchase parameters for the group and enabling at least one other user to join the first user based on the first user's purchase parameters; or
receiving, from the first user, a request to be matched with at least one other user, and wherein determining at least one real estate property corresponding to the purchase parameters includes filtering, from the plurality of real estate properties, for a real estate property having been previously selected by the first user for combined purchase with at least one other user.

20. A computer implemented method for search and purchase of real estate, comprising:
enabling a first user to establish a purchasing group including at least one other user;
establishing communication between users in the purchasing group;
receiving, from the purchasing group, purchase parameters for purchase of at least one real estate property;
filtering, from a plurality of real estate properties, for at least one real estate property corresponding to the purchase parameters of the purchasing group;
presenting the corresponding real estate properties to the purchasing group;
receiving, from the purchasing group, a selection of at least one of the corresponding real estate properties from the list;
obtaining, from at least one financial institution, financial information corresponding to each respective user in the purchasing group;
determining whether the purchasing group is financially qualified to purchase the selected at least one real estate property based on the combined financial information of each respective user in the group;
determining purchase cost information for the selected at least one real estate property specific to the purchasing group based on the obtained combined financial information of the group;
communicating the combined purchase cost information to the purchasing group;
receiving, from the purchasing group, a decision to purchase the selected at least one real estate property; and
establishing communication between a seller of the selected at least one real estate property, at least one financial institution, and each user of the group for purchase of the selected at least one real estate property by the purchasing group.
